(19) United States
(12) Patent Application Publication
(10) Pub. No.: US 2025/0377008 A1
(43) Pub. Date: Dec. 11, 2025

(54) EARTHING NUT AND METHOD OF MANUFACTURING THEREOF

(71) Applicant: AOYAMA SEISAKUSHO CO., LTD., Aichi (JP)

(72) Inventor: Kazuki AKATSUKA, Aichi (JP)

(73) Assignee: AOYAMA SEISAKUSHO CO., LTD., Aichi (JP)

(21) Appl. No.: 19/193,530

(22) Filed: Apr. 29, 2025

(30) Foreign Application Priority Data
Jun. 7, 2024 (JP) 2024-092666

(51) Int. Cl. F16B 39/30; B21D 53/24; H01R 4/66

(52) U.S. Cl. CPC F16B 39/30; B21D 53/24; H01R 4/66

(57) ABSTRACT

An earthing nut includes a thread formation portion having an internal thread, wherein the internal thread includes a reference thread portion, and an irregular-shaped thread portion having a shape different from a shape of the reference thread portion, a pitch of the irregular-shaped thread portion is different from a pitch of the reference thread portion, and an inclination angle of a pressured side flank face of the irregular-shaped thread portion is different from an inclination angle of a pressured side flank face of the reference thread portion.

### CROSS-REFERENCE

This application claims priority to Japanese patent application No. 2024-092666 filed on Jun. 7, 2024, the contents of which are fully incorporated herein by reference.

### BACKGROUND

### (1) Technical Field

The present disclosure relates to an earthing nut and a method of manufacturing thereof.

### (2) Description of Related Art

In the related art, JP 2004-36682 A discloses an earthing nut having a thread portion deformed by applying an external force. In the earthing nut of the related art, the deformed thread portion peels off the coating film of the bolt when the earthing nut is assembled to the coated bolt. As a result, the earthing nut and the bolt can be electrically connected, so that the earth performance is secured.

In this related art, an external force for deforming the thread portion is applied in a direction perpendicular to the axial direction of the thread portion. As a result, the inner peripheral face of the thread portion is plastically deformed so as to be curved inward, and has an inner diameter smaller than an initial predetermined inner diameter. Then, a portion of the thread portion, which is plastically deformed so as to have a small inner diameter, peels off the coating film of the bolt.

### SUMMARY

In the above-described earthing nut of the related art, in order to peel off the coating film of the bolt, the earthing nut is plastically deformed so that the inner diameter of the thread portion is small. In other words, the earthing nut of the related art has a function of peeling off the coating film of the bolt by deformation of the thread portion in the radial direction. Therefore, the screwing torque at the time of being assembled to the bolt is too high, which may adversely affect the tightening performance.

The present disclosure has been made in view of such a background, and an object thereof is to provide an earthing nut capable of securing earth performance while suppressing an increase in screwing torque.

In an aspect of the present disclosure,
an earthing nut includes a thread formation portion having an internal thread,
the internal thread includes
   a reference thread portion, and
   an irregular-shaped thread portion having a shape different from a shape of the reference thread portion,
a pitch of the irregular-shaped thread portion is different from a pitch of the reference thread portion, and
an inclination angle of a pressured side flank face of the irregular-shaped thread portion is different from an inclination angle of a pressured side flank face of the reference thread portion.

In another aspect of the present disclosure, a method of manufacturing an earthing nut includes
a deformation step of partly deforming a pressured side flank face in an internal thread provided on a nut by pressing a pin against part of an outer peripheral face of a thread formation portion of the nut, wherein
the pin includes a distal end portion configured to be pressed against the outer peripheral face, and the distal end portion has a shape inclined so as to be away from an axis of the internal thread as going from a side of a bearing face configured to be in contact with an object to be fastened toward an opposite side of the bearing face.

According to an aspect of the present disclosure, since the pitch and the inclination angle of the pressure side flank face of the irregular-shaped thread portion are different from those of the reference thread portion, the irregular-shaped thread portion can interfere with the bolt to peel off the coating film of the bolt. That is, since a function of peeling off the coating film of the bolt is provided by deformation of the irregular-shaped thread portion in the axial direction, it is possible to provide a function of peeling off the coating film of the bolt while suppressing deformation of the irregular-shaped thread portion in the radial direction. Therefore, since it is possible to suppress a decrease in the inner diameter of the internal thread, an increase in the screwing torque can be suppressed.

According to another aspect of the present disclosure, the pressure side flank face, which is a portion of the internal thread, is deformed so as to be raised opposite to the seat face of the nut. In the earthing nut manufactured as described above, the coating film of the bolt can be peeled off by the deformed pressure side flank face, so that earth performance can be secured. Moreover, since it is possible to suppress a decrease in the inner diameter of the internal thread, an increase in the screwing torque can be suppressed.

As described above, according to the above aspect, it is possible to provide an earthing nut capable of securing earth performance while suppressing an increase in screwing torque.

Note that the reference signs in parentheses in the claims indicate correspondence with specific means described in the embodiments to be described later, and do not limit the technical scope of the present disclosure.

### BRIEF DESCRIPTION OF THE DRAWINGS

FIG. 1 is an axial cross-sectional view illustrating an earthing nut, a bolt, a steel plate, and an object to be fastened according to a first embodiment;

FIG. 2 is a plan view illustrating the earthing nut according to the first embodiment;

FIG. 3 is a side view illustrating the earthing nut according to the first embodiment;

FIG. 4 is an axial cross-sectional view illustrating the earthing nut according to the first embodiment;

FIG. 5 is a cross-sectional view illustrating the earthing nut and a pin according to the first embodiment;

FIG. 6 is a cross-sectional view taken along line VI-VI of FIG. 2;

FIG. 7 is a cross-sectional view taken along line VII-VII of FIG. 2;

FIG. 8 is an axial cross-sectional view illustrating the earthing nut according to the first embodiment;

FIG. 9 is a cross-sectional view illustrating a fastening state of the earthing nut and the bolt according to the first embodiment; and

FIG. 10 is a plan view illustrating an earthing nut according to a second embodiment.

### DETAILED DESCRIPTION OF PREFERRED EMBODIMENTS

An earthing nut includes a thread formation portion having an internal thread, the internal thread includes a reference thread portion, and an irregular-shaped thread portion having a shape different from a shape of the reference thread portion, a pitch of the irregular-shaped thread portion is different from a pitch of the reference thread portion, and an inclination angle of a pressured side flank face of the irregular-shaped thread portion is different from an inclination angle of a pressured side flank face of the reference thread portion.

In the earthing nut, the irregular-shaped pressured side flank face may be formed in a region from a thread root to a thread crest of the irregular-shaped thread portion. The irregular-shaped thread portion can reliably interfere with a bolt to reliably peel off a coating film of the bolt.

In the earthing nut, an irregular-shaped flank angle that is a flank angle of the irregular-shaped thread portion may be larger than a reference flank angle that is a flank angle of the reference thread portion. The irregular-shaped thread portion can reliably interfere with a bolt to reliably peel off a coating film of the bolt.

In the earthing nut, the flank angle of the irregular-shaped thread portion may be an angle formed between an imaginary straight line connecting a point at a thread root and a point at a thread crest of one flank face and an imaginary straight line connecting a point at a thread root and a point at a thread crest of the other flank face. The irregular-shaped thread portion can reliably interfere with a bolt to reliably peel off a coating film of the bolt.

In the earthing nut, the irregular-shaped thread portion may include at least two thread grooves in a direction of an axis of the internal thread, and the at least two thread grooves each may have a flank angle larger than a flank angle of the reference thread portion. As compared with a case where only the flank angle of one of the thread grooves of the irregular-shaped thread portion is larger than the flank angle of the reference thread portion, the irregular-shaped thread portion can reliably interfere with the bolt to reliably peel off the coating film of the bolt.

In the earthing nut, the irregular-shaped thread portion may includes at least two threads adjacent to each other in a direction of an axis of the internal thread. As compared with a case where the irregular-shaped thread portion includes only one thread, the irregular-shaped thread portion can reliably interfere with the bolt to reliably peel off the coating film of the bolt.

In the earthing nut, the irregular-shaped thread portion of the internal thread may be partly formed in a circumferential direction of the internal thread. This makes it possible to reliably secure the earth performance while reliably suppressing the increase in the screwing torque.

In the earthing nut, the internal thread may include a plurality of the irregular-shaped thread portions in the circumferential direction. As compared with a case where the only one irregular-shaped thread portion is formed in the circumferential direction of the internal thread, the irregular-shaped thread portions reliably interferes with the bolt to reliably peel off the coating film of the bolt.

In the earthing nut, the plurality of the irregular-shaped thread portions may be formed only in one half region of the internal thread in the circumferential direction. The irregular-shaped thread portion can reliably interfere with a bolt to reliably peel off a coating film of the bolt. Further, since the region where the irregular-shaped thread portion is not formed can be continuously and widely secured in the circumferential direction, an increase in the screwing torque due to the irregular-shaped thread portion can be suppressed.

In the earthing nut, the thread formation portion may include a recess recessed toward an inner peripheral face of the thread formation portion on an outer peripheral face thereof, and the irregular-shaped thread portion may be formed in a region corresponding to the recess. According to this, it is possible to adopt a method of manufacturing an earthing nut in which a nut having a reference thread portion is first formed, and then an external force is applied to the outer peripheral face of the thread formation portion to form a recess, so that the reference thread portion is deformed to form an irregular-shaped thread portion. Therefore, the earthing nut having the irregular-shaped thread portion can be easily manufactured.

The earthing nut may include a bearing face constituting an end face of the internal thread at one end in a direction of the axis of the internal thread and configured to be in contact with an object to be fastened, and the recess may have an inclined face inclined so as to be away from the axis from an end portion close to the bearing face toward an end portion opposite to the bearing face. According to the above-described method of manufacturing an earthing nut, the pressured side flank face of the irregular-shaped thread portion can be formed so as to be raised toward the thread of the bolt, so that the pressured side flank face of the irregular-shaped thread portion can reliably interfere with the bolt.

In the direction of the axis of the earthing nut, an entire length of the recess in the direction of the axis of the internal thread may be greater than the reference pitch. According to the above-described method of manufacturing an earthing nut, the irregular-shaped thread portion can be formed such that the pressured side flank face reliably interferes with the bolt.

In the direction of the axis of the earthing nut, a length of the inclined face in the direction of the axis may be 90% or more of an entire length of the recess. According to the above-described method of manufacturing an earthing nut, the irregular-shaped thread portion can be formed such that the pressured side flank face reliably interferes with the bolt.

In the earthing nut, the recess may include a curved recessed face. According to the above-described method of manufacturing an earthing nut, the pressured side flank face of the irregular-shaped thread portion can be formed so as to be reliably raised toward the thread of the bolt, so that the pressured side flank face of the irregular-shaped thread portion can reliably interfere with the bolt.

A method of manufacturing an earthing nut includes a deformation step of partly deforming a pressured side flank face in an internal thread provided on a nut by pressing a pin against part of an outer peripheral face of a thread formation portion of the nut, wherein the pin includes a distal end portion configured to be pressed against the outer peripheral face, and the distal end portion has a shape inclined so as to be away from an axis of the internal thread as going from a side of a bearing face configured to be in contact with an object to be fastened toward an opposite side of the bearing face.

In the method of manufacturing an earthing nut, the deformation step, a recess may be formed on the outer peripheral face by pressing the pin against the part of the outer peripheral face, the recess being recessed toward an inner peripheral face of the thread formation portion. A pressured side flank face which is a portion of the internal thread can be reliably deformed.

### First Embodiment

### 1. Configuration of Earthing Nut 1

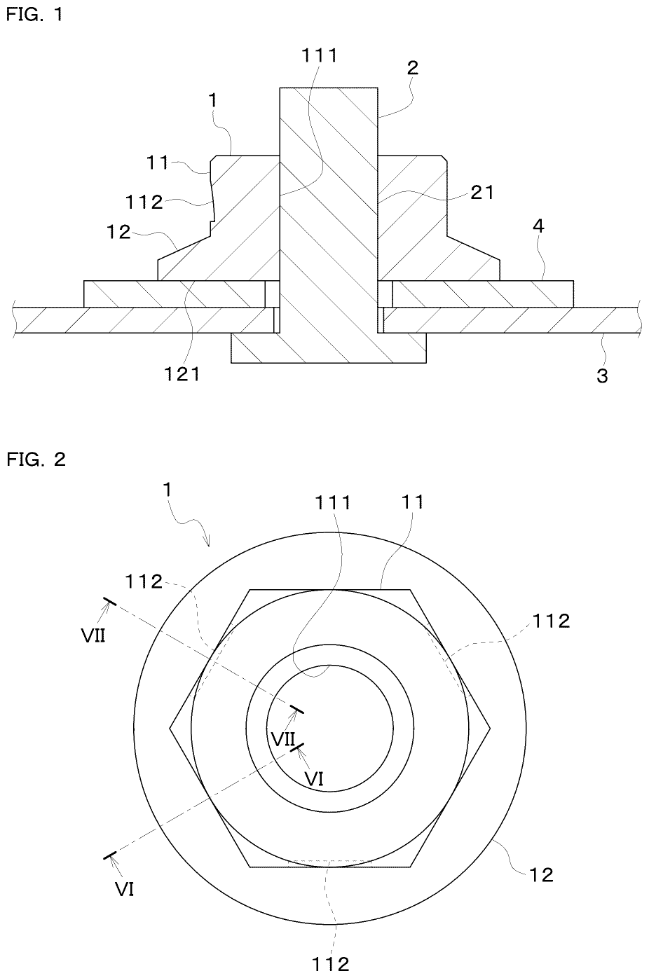

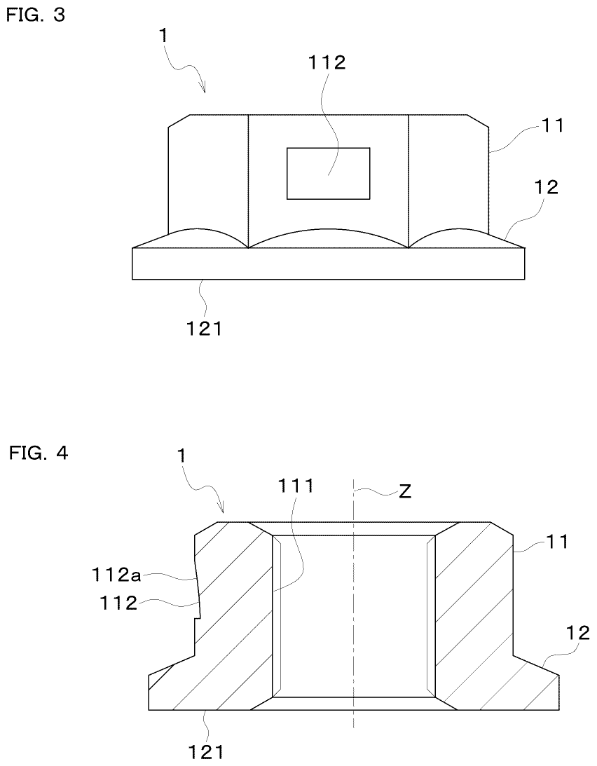

An earthing nut 1 according to a first embodiment will be described with reference to FIGS. 1, 2, 3, and 4. The earthing nut 1 is a nut that can be electrically connected to a bolt 2 by an internal thread 111 peeling off the coating film of the bolt 2 when assembled to the coated bolt 2 to secure the earth performance.

As illustrated in FIG. 1, the earthing nut 1 according to the present embodiment is used for fastening an object to be fastened 4 to a steel plate 3. The earthing nut 1 and the bolt 2 are made of a material that conducts electricity (for example, metal). In the bolt 2, at least a portion where an external thread 21 is formed is coated in advance. In the present embodiment, the bolt 2 is welded and fixed to the steel plate 3 in advance, and the bolt 2 and the steel plate 3 are entirely coated after the welding and fixing. In FIGS. 1 and 4, for convenience of illustration, illustration of specific shapes of the internal thread 111 of the earthing nut 1 and the external thread 21 of the bolt 2 is omitted. When the earthing nut 1 and the bolt 2 are fastened in a state where the object to be fastened 4 is sandwiched between the steel plate 3 and the earthing nut 1, the object to be fastened 4 is fastened to the steel plate 3.

The earthing nut 1 includes a thread formation portion 11 and a flange portion 12. In the present embodiment, the earthing nut 1 is a flange nut having a thread diameter (nominal diameter) of 6 mm. The thread formation portion 11 has a tubular shape, and has the internal thread 111 on the inner peripheral face. The internal thread 111 is screwed with the external thread 21 of the bolt 2. In the present embodiment, as illustrated in FIG. 2, the thread formation portion 11 has a hexagonal tubular shape. Therefore, the thread formation portion 11 has six planes on the outer peripheral face. As illustrated in FIG. 1, the flange portion 12 has a bearing face 121 that comes into contact with the object to be fastened 4. The flange portion 12 is disposed coaxially with the thread formation portion 11, and has a larger radial dimension than the thread formation portion 11. The earthing nut 1 is not necessarily a flange nut, and may be a nut in which the flange portion 12 is not formed.

### 2. Detailed Configuration of Earthing Nut 1

As illustrated in FIGS. 2, 3, and 4, the thread formation portion 11 of the earthing nut 1 has a recess 112 recessed toward the inner peripheral face in the outer peripheral face. In the present embodiment, as illustrated in FIG. 2, the recesses 112 are formed in three planes out of the six planes formed on the outer peripheral face of the thread formation portion 11, and planes in which the recesses 112 are formed and planes in which the recesses 112 are not formed are alternately disposed in the circumferential direction of the thread formation portion 11.

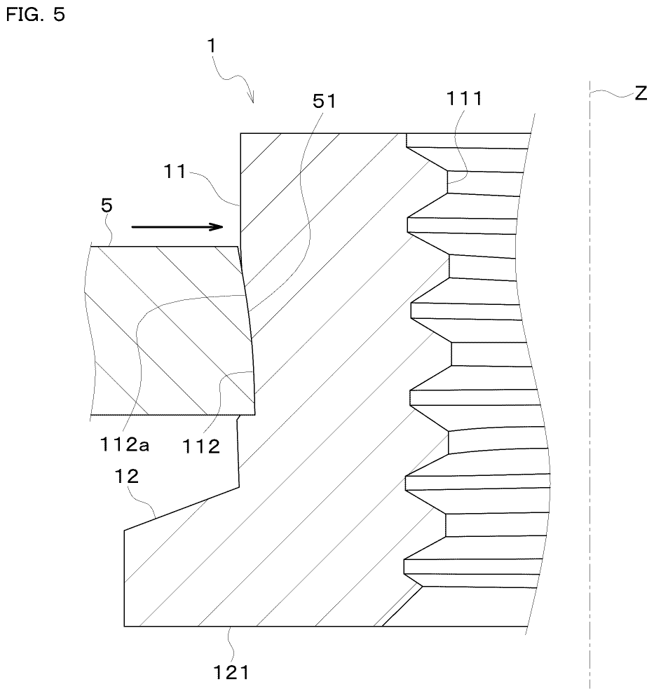

The recesses 112 are formed by crimping. Specifically, as illustrated in FIG. 5, the thread formation portion 11 has the recesses 112 formed by pressing a crimping pin 5 against the outer peripheral face. In the present embodiment, the crimping pin 5 presses the outer peripheral face of the thread formation portion 11 in a direction perpendicular to an axis Z of the thread formation portion 11. In the present embodiment, since the crimping pin 5 is pressed against three planes among the six planes formed on the outer peripheral face of the thread formation portion 11, the recesses 112 are formed in three planes among the six planes formed on the outer peripheral face of the thread formation portion 11.

A distal end portion 51 of the crimping pin 5, which is pressed against the outer peripheral face of the thread formation portion 11, has a face shape inclined with respect to the axis Z of the thread formation portion 11. Specifically, the distal end portion 51 has a face shape inclined so as to be away from the axis Z from an end portion close to the bearing face 121 (lower end portion in FIG. 5) toward an end portion opposite to the bearing face 121 (upper end portion in FIG. 5).

Therefore, the shape of the recess 112 is a shape having an inclined face 112a inclined with respect to the axis Z of the thread formation portion 11 according to the shape of the distal end portion 51 of the crimping pin 5. Specifically, the inclined face 112a constitutes a face inclined so as to be away from the axis Z from an end portion close to the bearing face 121 (lower end portion in FIGS. 4 and 5) toward an end portion opposite to the bearing face 121 (upper end portion in FIGS. 4 and 5). That is, the recess 112 has a shape in which the depth of the recess decreases from a portion close to the bearing face 121 (lower side in FIGS. 4 and 5) toward a portion opposite to the bearing face 121 (upper side in FIGS. 4 and 5) in the direction of the axis Z of the thread formation portion 11 (vertical direction in FIGS. 4 and 5). Since the distal end portion 51 of the crimping pin 5 is curved and inclined, the inclined face 112a of the recess 112 is also curved and inclined. In other words, the recess 112 constitutes a curved recessed face.

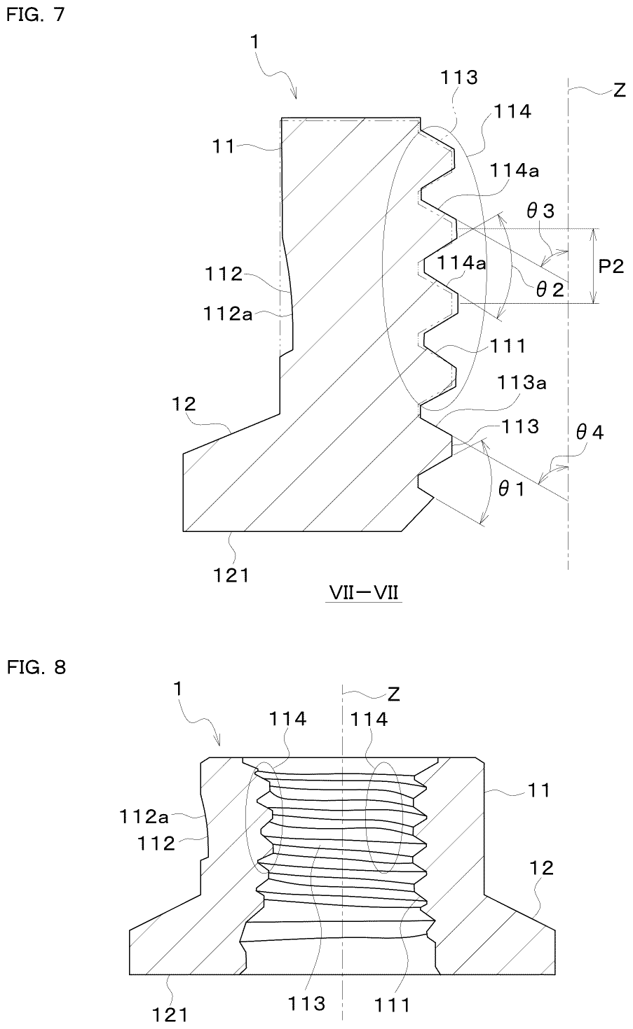

When the crimping pin 5 is pressed against the thread formation portion 11, a portion other than the recess 112 is also deformed. In FIG. 7, among the lines indicating the cross-sectional shape of the earthing nut 1, a two-dot chain line indicates the cross-sectional shape of the earthing nut 1 before the crimping pin 5 is pressed against the outer peripheral face of the thread formation portion 11 (that is, before deformation), and a solid line indicates the cross-sectional shape of the earthing nut 1 after the crimping pin 5 is pressed against the outer peripheral face of the thread formation portion 11 (that is, after deformation).

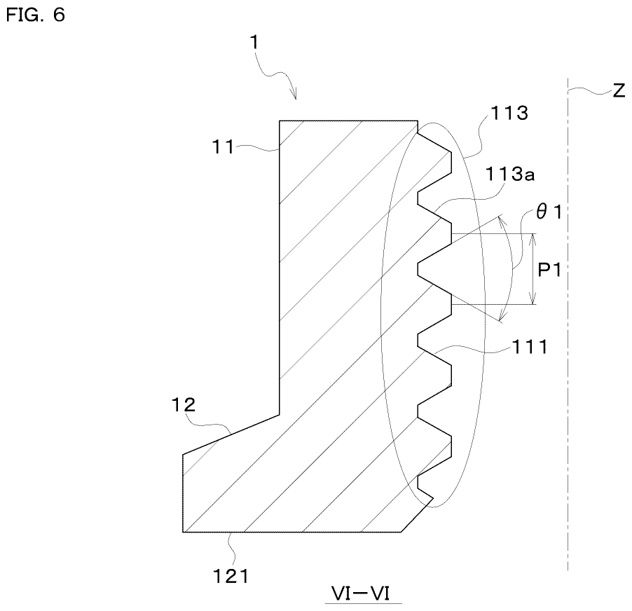

As illustrated in FIGS. 6, 7, and 8, the internal thread 111 of the thread formation portion 11 has a reference thread portion 113 and an irregular-shaped thread portion 114. The reference thread portion 113 is a portion that is not deformed before and after the crimping pin 5 is pressed against, and the irregular-shaped thread portion 114 is a portion, of the internal thread 111, that is deformed when the crimping pin 5 is pressed against.

In other words, the reference thread portion 113 is a portion in which the shape of the internal thread 111 is similar to that of a normal nut, and the irregular-shaped thread portion 114 is a portion in which the shape of the internal thread 111 is different from that of the reference thread portion 113.

In at least a partial region of the irregular-shaped thread portion 114, the thread of the internal thread 111 has a shape raised opposite to the bearing face 121 (the upper side in FIG. 7) as compared with the shape before deformation. The inner diameter of the irregular-shaped thread portion 114 is smaller than the inner diameter of the reference thread portion 113 in at least a partial region. The inner diameter of the irregular-shaped thread portion 114 is slightly smaller than that of the reference thread portion in a portion smaller than the inner diameter of the reference thread portion 113.

As described above, when the crimping pin 5 is pressed against the outer peripheral face of the thread formation portion 11, the recess 112 is formed, and the inner peripheral face of the thread formation portion 11 is deformed in the vicinity of the recess 112 to form the irregular-shaped thread portion 114. Corresponding to the inclined shape of the distal end portion 51 of the crimping pin 5, in at least a partial region of the irregular-shaped thread portion 114, the thread of the internal thread 111 has a shape raised opposite to the bearing face 121 (the upper side in FIG. 7).

As illustrated in FIG. 8, the irregular-shaped thread portion 114 is formed only at a portion of the inner peripheral face of the thread formation portion 11 in the circumferential direction. In the present embodiment, the recesses 112 are formed in three of the six planes formed on the outer peripheral face of the thread formation portion 11, and planes in which the recesses 112 are formed and planes in which the recesses 112 are not formed are alternately disposed in the circumferential direction of the thread formation portion 11. Therefore, the irregular-shaped thread portion 114 is formed at three locations at equal intervals in the circumferential direction in the inner peripheral face of the thread formation portion 11 of the earthing nut 1.

One pitch P2 of the irregular-shaped thread portions 114 is different from a pitch P1 of the reference thread portion 113. As illustrated in FIGS. 6 and 7, an inclination angle θ3 of a pressured side flank face 114a of at least a portion of the irregular-shaped thread portion 114 is different from an inclination angle θ4 of a pressured side flank face 113a of the reference thread portion 113. The pressured side flank face is a flank face (upper side in FIG. 7) that directly receives a load when the earthing nut 1 is screwed in and a load is applied. The flank face is a face that connects the crest and the root of the thread. As the inclination angle θ3 of the pressured side flank face 114a of at least a portion of the irregular-shaped thread portion 114 and the inclination angle θ4 of the pressured side flank face 113a of the reference thread portion 113 are exemplified in FIG. 7, the inclination angle of the pressured side flank face is an angle of the pressured side flank face based on the direction of the axis Z of the thread formation portion 11 (the vertical direction in FIGS. 6 and 7).

The pressured side flank face 114a of at least a portion of the irregular-shaped thread portion 114 is formed in a region from the thread root to the thread crest of the irregular-shaped thread portion 114. That is, in the thread groove of the irregular-shaped thread portion 114, the face (the upper side in FIG. 7) that directly receives the load when a load is applied by being screwed is a flat face as a whole, and the whole flat face constitutes a flank face, and does not have a portion such as a projection partially protruding from the flank face.

The irregular-shaped thread portion 114 is formed so as to include at least two thread grooves adjacent to each other in the direction of the axis Z (the vertical direction in FIG. 7). In the example of FIG. 7, the irregular-shaped thread portion 114 is formed to include three thread grooves adjacent to each other in the direction of the axis Z.

A flank angle θ2 of the irregular-shaped thread portions 114 is larger than a flank angle θ1 of the reference thread portion 113. The flank angle θ2 of the irregular-shaped thread portions 114 is an angle formed by an imaginary straight line connecting a point at the thread root and a point at the thread crest of one flank face and an imaginary straight line connecting a point at the thread root and a point at the thread crest of the other flank face.

The entire length of the recess 112 in the direction of the axis Z is larger than the pitch P1 of the reference thread portion 113. In the direction of the axis Z, the length of the inclined face 112a of the recess 112 is 90% or more of the entire length of the recess 112. That is, in the direction of the axis Z, the inclined face 112a occupies most of the recess 112.

### 3. Method of Manufacturing Earthing Nut 1

A method of manufacturing the earthing nut 1 will be described with reference to FIGS. 5, 6, 7, and 8. First, in a nut forming step, a normal flange nut is formed by forging, tapping, or the like. In the nut forming step, the entire internal thread 111 of the thread formation portion 11 is formed to be the reference thread portion 113. That is, in the nut forming step, the entire internal thread 111 of the thread formation portion 11 is formed in a normal internal thread shape.

Next, in an irregular-shaped thread forming step, a portion of the internal thread 111 of the thread formation portion 11 is deformed to form the irregular-shaped thread portion 114. Specifically, as illustrated in FIG. 5, the crimping pin 5 is pressed against the outer peripheral face of the thread formation portion 11 of the flange nut formed in the nut forming step in a direction perpendicular to the axis Z of the thread formation portion 11. As a result, as illustrated in FIGS. 7 and 8, the thread formation portion 11 has the recess 112 in the outer peripheral face, and a portion of the inner peripheral face of the thread formation portion 11 is deformed by the stress generated by the crimping pin 5 being pressed against to form the irregular-shaped thread portion 114. In other words, the irregular-shaped thread forming step is a deformation step.

At this time, since the distal end portion 51 of the crimping pin 5 has a face shape inclined so as to be away from the axis Z from an end portion (lower end portion in FIG. 5) close to the bearing face 121 toward an end portion (upper end portion in FIG. 5) opposite to the bearing face 121, in at least a partial region of the irregular-shaped thread portion 114, the thread of the internal thread 111 is raised opposite (upper side in FIG. 7) to the bearing face 121 corresponding to the shape of the distal end portion 51 of the crimping pin 5.

### 4. Fastening State Between Earthing Nut 1 and Bolt 2

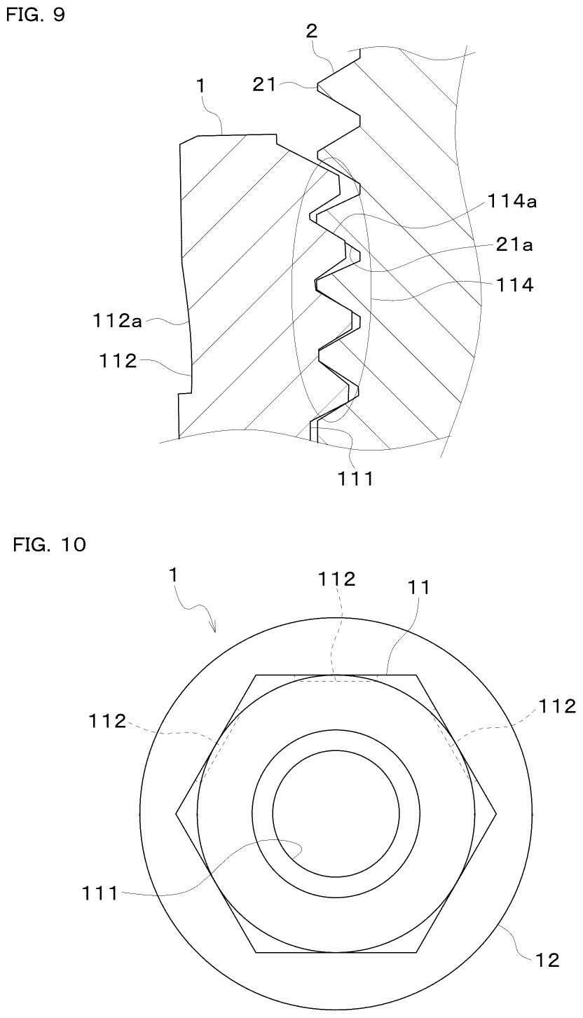

A fastening state of the earthing nut 1 and the bolt 2 will be described with reference to FIG. 9. When the internal thread 111 of the earthing nut 1 and an external thread 21 of the bolt 2 are screwed together in fastening of the earthing nut 1 and the bolt 2, the irregular-shaped thread portion 114 of the earthing nut 1 interferes with the external thread 21 of the bolt 2.

At this time, although the inner diameter of the irregular-shaped thread portion 114 of the earthing nut 1 in at least partial region is smaller than the inner diameter of the reference thread portion 113, even a portion smaller than the inner diameter of the reference thread portion 113 is slightly smaller than the reference thread portion 113, but is substantially the same as the inner diameter of the reference thread portion 113, so that an increase in the screwing torque can be suppressed. In addition, since the irregular-shaped thread portion 114 of the earthing nut 1 is formed only on a portion of the inner peripheral face of the thread formation portion 11 in the circumferential direction, it is possible to suppress an increase in the screwing torque due to interference of the irregular-shaped thread portion 114 of the earthing nut 1 with the external thread 21 of the bolt 2 as compared with a case where the irregular-shaped thread portion 114 of the earthing nut 1 is formed on the inner peripheral face of the thread formation portion 11 over the entire circumference.

When an axial force is generated by further screwing the earthing nut 1 and the bolt 2, the pressured side flank face 114a of at least a portion of the irregular-shaped thread portion 114 of the earthing nut 1 strongly interferes with the pressured side flank face 21a of the external thread 21 of the bolt 2, and by piercing the coating film of the external thread 21, the coating film is peeled off and the earthing nut and the bolt are metal-touched. As a result, the contact resistance value is reduced, and the earth performance is secured.

### 5. Action and Effect

According to the earthing nut 1 of the present embodiment, the pitch P2 of the irregular-shaped thread portions 114 is different from the reference pitch P1, and the inclination angle of the pressured side flank face 114a of at least a portion of the irregular-shaped thread portion 114 is different from the inclination angle of the pressured side flank face 113a of the reference thread portion 113, so that the irregular-shaped thread portion 114 can interfere with the bolt 2 to peel off the coating film of the bolt 2. That is, since at least a portion of the irregular-shaped thread portion 114 is deformed in the axial direction (that is, the direction of the axis Z) to have a function of peeling off the coating film of the bolt 2, it is possible to have a function of peeling off the coating film of the bolt 2 while suppressing the deformation of the irregular-shaped thread portion 114 in the radial direction. Therefore, since it is possible to suppress a decrease in the inner diameter of the internal thread 111, an increase in the screwing torque can be suppressed. Therefore, it is possible to ensure the earth performance while suppressing the increase in the screwing torque.

According to the earthing nut 1 of the present embodiment, since the pressured side flank face 114a of at least a portion of the irregular-shaped thread portion 114 is formed in a region from the thread root to the thread crest of at least a portion of the irregular-shaped thread portion 114, the irregular-shaped thread portion 114 can reliably interfere with the bolt 2 to reliably peel off the coating film of the bolt 2.

According to the earthing nut 1 of the present embodiment, since the flank angle θ2 of the irregular-shaped thread portions 114 is larger than the flank angle θ1 of the reference thread portion 113, the irregular-shaped thread portion 114 reliably interferes with the bolt 2, and the coating film of the bolt 2 can be reliably peeled off.

According to the earthing nut 1 of the present embodiment, the flank angle θ2 of the irregular-shaped thread portions 114 is an angle formed by an imaginary straight line connecting a point at the thread root and a point at the thread crest of one flank face and an imaginary straight line connecting a point at the thread root and a point at the thread crest of the other flank face. Since the flank angle θ2 of the irregular-shaped thread portions 114 is larger than the reference flank angle θ1, the irregular-shaped thread portion 114 reliably interferes with the bolt 2, and the coating film of the bolt 2 can be reliably peeled off.

According to the earthing nut 1 of the present embodiment, since the irregular-shaped thread portion 114 includes at least two threads adjacent to each other in the direction of the axis Z of the internal thread 111, it is possible to cause the irregular-shaped thread portion 114 to reliably interfere with the bolt 2 and to reliably peel off the coating film of the bolt 2 as compared with a case where the irregular-shaped thread portion 114 includes only one thread.

According to the earthing nut 1 of the present embodiment, the irregular-shaped thread portion 114 is formed at a portion of the internal thread 111 in the circumferential direction, and the reference thread portion 113 is formed at a remaining portion of the internal thread 111 in the circumferential direction. Therefore, it is possible to reliably secure the earth performance while reliably suppressing the increase in the screwing torque.

According to the earthing nut 1 of the present embodiment, since a plurality of the irregular-shaped thread portions 114 is formed in the circumferential direction of the internal thread 111, it is possible to cause the irregular-shaped thread portion 114 to reliably interfere with the bolt 2 and to reliably peel off the coating film of the bolt 2 as compared with a case where the one irregular-shaped thread portion 114 is formed in the circumferential direction of the internal thread 111.

According to the earthing nut 1 of the present embodiment, a portion of the outer peripheral face of the thread formation portion 11, the portion corresponding to the irregular-shaped thread portion 114, has the recess 112 recessed toward the inner peripheral face of the thread formation portion 11. According to this, it is possible to adopt a method of manufacturing the earthing nut 1 in which the nut having the reference thread portion 113 is first formed, and then an external force is applied to the outer peripheral face of the thread formation portion 11 to form the recess 112, whereby the reference thread portion 113 is deformed to form the irregular-shaped thread portion 114. Therefore, the earthing nut 1 having the irregular-shaped thread portion 114 can be easily manufactured.

According to the earthing nut 1 of the present embodiment, the recess 112 has the inclined face 112a inclined so as to be away from the axis Z from an end portion close to the bearing face 121 toward an end portion opposite to the bearing face 121. As a result, according to the above-described method of manufacturing the earthing nut 1, the pressured side flank face 114a of at least a portion of the irregular-shaped thread portion 114 can be formed so as to be raised toward the thread of the bolt 2, so that the pressured side flank face 114a of at least a portion of the irregular-shaped thread portion 114 can reliably interfere with the bolt 2.

According to the earthing nut 1 of the present embodiment, since the entire length of the recess 112 in the direction of the axis Z is larger than the pitch P1 of the reference thread portion 113, the irregular-shaped thread portion 114 can be formed so that the pressured side flank face 114a of at least a portion of the irregular-shaped thread portion 114 reliably interferes with the bolt 2 according to the above-described method of manufacturing the earthing nut 1.

According to the earthing nut 1 of the present embodiment, since the length of the inclined face 112a in the direction of the axis Z is 90% or more of the entire length of the recess 112, the irregular-shaped thread portion 114 can be formed so that the pressured side flank face 114a of at least a portion of the irregular-shaped thread portion 114 reliably interferes with the bolt 2 according to the above-described method of manufacturing the earthing nut 1.

According to the earthing nut 1 of the present embodiment, since the recess 112 constitutes a curved recessed face, the pressured side flank face 114a of at least a portion of the irregular-shaped thread portion 114 can be formed to be reliably raised toward the thread of the bolt 2 according to the above-described method of manufacturing the earthing nut 1. Therefore, the pressured side flank face 114a of at least a portion of the irregular-shaped thread portion 114 can reliably interfere with the bolt 2.

The method of manufacturing the earthing nut 1 of the present embodiment includes the deformation step of deforming the pitch of a portion of the internal thread 111 and the pressured side flank face by pressing the pin 5 against a portion of the outer peripheral face of the thread formation portion 11, of the nut, where the internal thread 111 is formed and applying an external force, and the distal end portion 51, of the pin 5, pressed against the outer peripheral face of the thread formation portion 11 has a face shape inclined so as to be away from the axis Z of the internal thread 111 from a portion close to the bearing face 121 of the nut toward a portion opposite to the bearing face 121.

According to this, the pressured side flank face which is a portion of the internal thread 111 is deformed so as to be raised opposite to the bearing face 121 of the nut to form the pressured side flank face 114a of at least a portion of the irregular-shaped thread portion 114. In the earthing nut 1 manufactured as described above, the coating film of the bolt 2 can be peeled off by the pressured side flank face 114a of at least a portion of the irregular-shaped thread portion 114, so that the earth performance can be secured. Moreover, since it is possible to suppress a decrease in the inner diameter of the internal thread 111, an increase in the screwing torque can be suppressed. Therefore, it is possible to provide the earthing nut 1 capable of securing the earth performance while suppressing the increase in the screwing torque.

According to the method of manufacturing the earthing nut 1 of the present embodiment, in the deformation step, the pin 5 is pressed against a portion of the outer peripheral face of the thread formation portion 11 to form the recess 112 recessed toward the inner peripheral face of the thread formation portion 11 on the outer peripheral face of the thread formation portion 11, so that it is possible to reliably deform the pressured side flank face which is a portion of the internal thread 111 to reliably form the pressured side flank face 114a of at least a portion of the irregular-shaped thread portion 114.

### Second Embodiment

In the above embodiment, the three irregular-shaped thread portions 114 of the earthing nut 1 are formed at equal intervals in the circumferential direction on the inner peripheral face of the thread formation portion 11. In the present embodiment, as illustrated in FIG. 10, three irregular-shaped thread portions 114 are formed only in one half region (half region located on the upper side in FIG. 10) in the circumferential direction on the inner peripheral face of the thread formation portion 11, but no irregular-shaped thread portion is formed in the other half region (half region located on the lower side in FIG. 10) in the circumferential direction.

With such a configuration, it is possible to continuously and largely secure a region where the irregular-shaped thread portion 114 is not formed in the circumferential direction of the internal thread 111 and hence, when the earthing nut 1 and the bolt 2 are fastened to each other, it is possible to further suppress an increase in a screwing torque due to the irregular-shaped thread portion 114.

According to the earthing nut 1 of the present embodiment, since the irregular-shaped thread portion 114 is formed only at one half region of the internal thread 111 in the circumferential direction, it is possible to cause the irregular-shaped thread portion 114 to reliably interfere with the bolt 2 and to reliably peel off the coating film of the bolt 2. Furthermore, since the region where the irregular-shaped thread portion 114 is not formed can be secured continuously and widely in the circumferential direction, an increase in the screwing torque due to the irregular-shaped thread portion 114 can be suppressed.

### Other Embodiments

In the above embodiment, the pitch P2 of the irregular-shaped thread portions 114 different from the reference pitch P1 is configured by one pitch of the irregular-shaped thread portions 114, but the pitch P2 of the irregular-shaped thread portions 114 different from the pitch P1 of the reference thread portion 113 may be configured by at least two pitches of the irregular-shaped thread portions 114.

In the above embodiment, the flank angle θ2 that is one flank angle of the irregular-shaped thread portion 114 is larger than the flank angle θ1 of the reference thread portion 113, but the flank angle θ2 of each of at least two thread grooves of the irregular-shaped thread portion 114, the at least two thread grooves in the direction of the axis Z of the internal thread 111, may be larger than the reference flank angle θ1. As compared with the case where the flank angle of one thread groove of the irregular-shaped thread portion 114 is larger than the flank angle of the reference thread portion 113, the irregular-shaped thread portion 114 can reliably interfere with the bolt 2 to reliably peel off the coating film of the bolt 2.

In the above embodiment, the inner diameter of the irregular-shaped thread portion 114 of the earthing nut 1 in at least a partial region is smaller than the inner diameter of the reference thread portion 113, but the inner diameter of the irregular-shaped thread portion 114 of the earthing nut 1 may be smaller than the inner diameter of the reference thread portion 113 in the entire region of the irregular-shaped thread portion 114.

In the above embodiment, the earthing nut 1 is a flange nut having a screw diameter (nominal diameter) of 6 mm, but the screw diameter (nominal diameter) of the earthing nut 1 is not limited to 6 mm.

In the above embodiment, the thread formation portion 11 of the earthing nut 1 has a hexagonal tubular shape, but the tubular shape of the thread formation portion 11 is not limited to the hexagonal shape.

In the above embodiment, the planar shape of the flange portion 12 of the earthing nut 1 is circular, but the planar shape of the flange portion 12 is not limited to circular.

In the above embodiment, one crimping pin 5 is pressed against the thread formation portion 11 in the direction of the axis Z, but two or more crimping pins 5 may be pressed against the thread formation portion 11 in the direction of the axis Z.

In the above embodiment, the distal end portion 51 of the pin 5 and the inclined face 112a of the recess 112 form a curved face, but the shapes of the distal end portion 51 of the pin 5 and the inclined face 112a of the recess 112 are not limited thereto. For example, the distal end portion 51 of the pin 5 and the inclined face 112a of the recess 112 may form a plane.

In the above embodiment, the direction in which the crimping pin 5 is pressed against the outer peripheral face of the thread formation portion 11 is a direction perpendicular to the axis Z of the thread formation portion 11, but the direction in which the crimping pin 5 is pressed against is not limited thereto, and the direction in which the crimping pin 5 is pressed against may be a direction non-perpendicular to the axis Z of the thread formation portion 11.

In the above embodiment, the three irregular-shaped thread portions 114 of the earthing nut 1 are formed in the circumferential direction on the inner peripheral face of the thread formation portion 11, but the number of the irregular-shaped thread portions 114 is not limited thereto, and a plurality of the irregular-shaped thread portions other than three may be formed, or one irregular-shaped thread portion may be formed.

What is claimed is:

1. An earthing nut comprising:
a thread formation portion having an internal thread, wherein
the internal thread includes
a reference thread portion, and
an irregular-shaped thread portion having a shape different from a shape of the reference thread portion,
a pitch of the irregular-shaped thread portion is different from a pitch of the reference thread portion, and
an inclination angle of a pressured side flank face of the irregular-shaped thread portion is different from an inclination angle of a pressured side flank face of the reference thread portion.

2. The earthing nut according to claim 1, wherein the pressured side flank face of the irregular-shaped thread portion is formed in a region from a thread root to a thread crest of the irregular-shaped thread portion.

3. The earthing nut according to claim 1, wherein a flank angle of the irregular-shaped thread portion is larger than a flank angle of the reference thread portion.

4. The earthing nut according to claim 3, wherein the flank angle of the irregular-shaped thread portion is an angle formed between an imaginary straight line connecting a point at a thread root and a point at a thread crest of one flank face and an imaginary straight line connecting a point at a thread root and a point at a thread crest of the other flank face.

5. The earthing nut according to claim 1, wherein the irregular-shaped thread portion includes at least two thread grooves in a direction of an axis of the internal thread, and
the at least two thread grooves each have a flank angle larger than a flank angle of the reference thread portion.

6. The earthing nut according to claim 1, wherein the irregular-shaped thread portion includes at least two threads adjacent to each other in a direction of an axis of the internal thread.

7. The earthing nut according to claim 1, wherein
the irregular-shaped thread portion of the internal thread is partly formed in a circumferential direction of the internal thread.

8. The earthing nut according to claim 7, wherein the internal thread includes a plurality of the irregular-shaped thread portions in the circumferential direction.

9. The earthing nut according to claim 8, wherein the plurality of the irregular-shaped thread portions is formed only in one half region of the internal thread in the circumferential direction.

10. The earthing nut according to claim 1, wherein the thread formation portion includes a recess recessed toward an inner peripheral face of the thread formation portion on an outer peripheral face thereof, and
the irregular-shaped thread portion is formed in a region corresponding to the recess.

11. The earthing nut according to claim 10, further comprising
a bearing face constituting an end face of the internal thread at one end in a direction of the axis of the internal thread and configured to be in contact with an object to be fastened, wherein
the recess has an inclined face inclined so as to be away from the axis from an end portion close to the bearing face toward an end portion opposite to the bearing face.

12. The earthing nut according to claim 10, wherein an entire length of the recess in the direction of the axis of the internal thread is greater than the reference pitch.

13. The earthing nut according to claim 11, wherein a length of the inclined face in the direction of the axis is 90% or more of an entire length of the recess.

14. The earthing nut according to claim 10, wherein the recess includes a curved recessed face.

15. A method of manufacturing an earthing nut, the method comprising:
a deformation step of partly deforming a pressured side flank face in an internal thread provided on a nut by pressing a pin against part of an outer peripheral face of a thread formation portion of the nut, wherein
the pin includes a distal end portion configured to be pressed against the outer peripheral face, and the distal end portion has a shape inclined so as to be away from an axis of the internal thread as going from a side of a bearing face configured to be in contact with an object to be fastened toward an opposite side of the bearing face.

16. The method according to claim 15, wherein in the deformation step, a recess is formed on the outer peripheral face by pressing the pin against the part of the outer peripheral face, the recess being recessed toward an inner peripheral face of the thread formation portion.
